(19) United States
(12) Patent Application Publication
(10) Pub. No.: US 2016/0019726 A1
(43) Pub. Date: Jan. 21, 2016

(54) FARE COLLECTING APPARATUS AND METHOD HAVING WIRELESS COMMUNICATION ABILITY

(71) Applicant: SPX Corporation, Charlotte, NC (US)

(72) Inventors: Bruce R. Joy, Elks Grove Village, IL (US); Andrew Chan, Elks Grove Village, IL (US); Kirk Hoffman, Elks Grove Village, IL (US)

(21) Appl. No.: 14/800,131

(22) Filed: Jul. 15, 2015

Related U.S. Application Data
(60) Provisional application No. 62/025,320, filed on Jul. 16, 2014.
(60) Provisional application No. 62/025,282, filed on Jul. 16, 2014.

(51) Int. Cl. G07B 15/00; G06Q 50/26

(52) U.S. Cl. CPC G07B 15/00; G06Q 50/26

(57) ABSTRACT

A fare collection machine is provided. The fare collection machine includes: a controller; a database operatively connected to the controller configured to receive and provide data from the controller; a display screen operatively connected to the controller; a user input device operably connected to the controller; a payment input device operably connected to the controller; a data input device operatively connected to the controller, the data input device configured to input to the controller data collected on the same vehicle the fare collection machine is located; and a wireless communication device configured to commutate with a remote communication device.

### CROSS REFERENCE TO PRIOR APPLICATIONS

This application claims the benefit from U.S. Provisional Application No. 62/025,320 and U.S. Provisional application No. 62/025,282 both filed on Jul. 16, 2014, which are both hereby incorporated by reference for all purposes as if fully set forth herein.

### FIELD OF THE INVENTION

The present invention relates generally to a fare collection apparatus and method. More particularly, the present invention relates to a fare collection apparatus and method for collecting fares associated with public transportation where the fare collection apparatus has wireless communication ability.

### BACKGROUND OF THE INVENTION

Public transportation systems have long used systems or methods of collecting fares. Many traditional systems relied on an employee such as, for example, a bus driver of the transportation system to visually confirm that the fare paid by the passenger is the correct amount. For example, a passenger would use paper currency or coins and place the currency or coins in the farebox. The driver would then visually confirm that the fare was the correct amount. Then the passenger would get on the bus. In some instances, transfers or tokens may also be used to pay a fare and these too would need to be visually confirmed by the driver.

Fare collection systems gradually became more sophisticated and allowed other forms of payment such as radio frequency identification (RFID) cards (Smart cards) or other cashless ways for passengers to make payments. With the increased use of electronics to make payments, some systems would electronically store how much money was collected. Some systems would download this information to a transit authority database or electronic system when the bus or other equipment finished its shift and returned to its garage.

Some drawbacks to these type of systems include a lack of communication between the farebox electronically saved data and the transit authority until a vehicle would finish its shift and download the data. Other drawbacks include fare collection systems that can only accept a limited amount of ways to make payments such as, for example, cash, coins, tokens, transfers, RFID (Smart) cards.

Accordingly, it is desirable to provide a method and apparatus that allows a variety of different ways for a passenger to make a fare payment and improved communication between the fare collection apparatus and the transit authority. In some embodiments, it may be desirable to also provide additional data gathered are compiled by the fare collection apparatus to be communicated to the transit authority in addition to collected fare data.

### SUMMARY OF THE INVENTION

The foregoing needs are met, to a great extent, by some embodiments in accordance with the present invention, wherein in one aspect an apparatus is provided that in some embodiments provides a method and apparatus that allows a variety of different ways for a passenger to make a fare payment and improved communication between the fare collection apparatus and the transit authority. In some embodiments, it may be desirable to also provide additional data gathered and compiled by the fare collection apparatus to be communicated to the transit authority in addition to collected fare data.

In accordance with one embodiment of the present invention, a fare collection machine is provided. The fare collection machine may include: a controller; a database operatively connected to the controller configured to receive and provide data from the controller; a display screen operatively connected to the controller; a user input device operably connected to the controller; a payment input device operably connected to the controller; a data input device operatively connected to the controller, the data input device configured to input to the controller data collected on the same vehicle the fare collection machine is located; and a wireless communication device configured to commutate with a remote communication device.

In accordance with another embodiment of the present invention, a method of obtaining passenger payment information is provided. The method may include: configuring a farebox located on a vehicle to input passenger payment information; wirelessly transmitting the passenger payment information to a receiver located remotely from the vehicle.

In accordance with yet another embodiment of the present invention, a fare collection machine is provided. The fare collection machine may include: means for processing; means for storing and retrieving data operatively connected to the means for processing configured to receive and provide data from the means for processing; means for displaying data operatively connected to the means for processing; means for inputting data operably connected to the means for processing; means for inputting payment data operably connected to the means for processing; second means for inputting data operatively connected to the means for processing, the second means for inputting data configured to input to the means for processing data collected on the same vehicle the fare collection machine is located; and means for wirelessly communicating configured to commutate with a communication device not located on the vehicle the collection machine is located.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram of a fare collection box in accordance with the present disclosure.

FIG. 2 is a schematic diagram showing things that can be in communication with the fare collection box and accordance with the disclosure.

FIG. 3 is a schematic diagram of things that can be in communication with the microprocessor associated with the fare collection box in accordance with the disclosure.

### DETAILED DESCRIPTION

The invention will now be described with reference to the drawing figures, in which like reference numerals refer to like parts throughout. An embodiment in accordance with the present invention provides a farebox and a method of collecting fares in a variety of ways. In some embodiments the farebox and method may also include processing data and transmitting data associated with the fare collection.

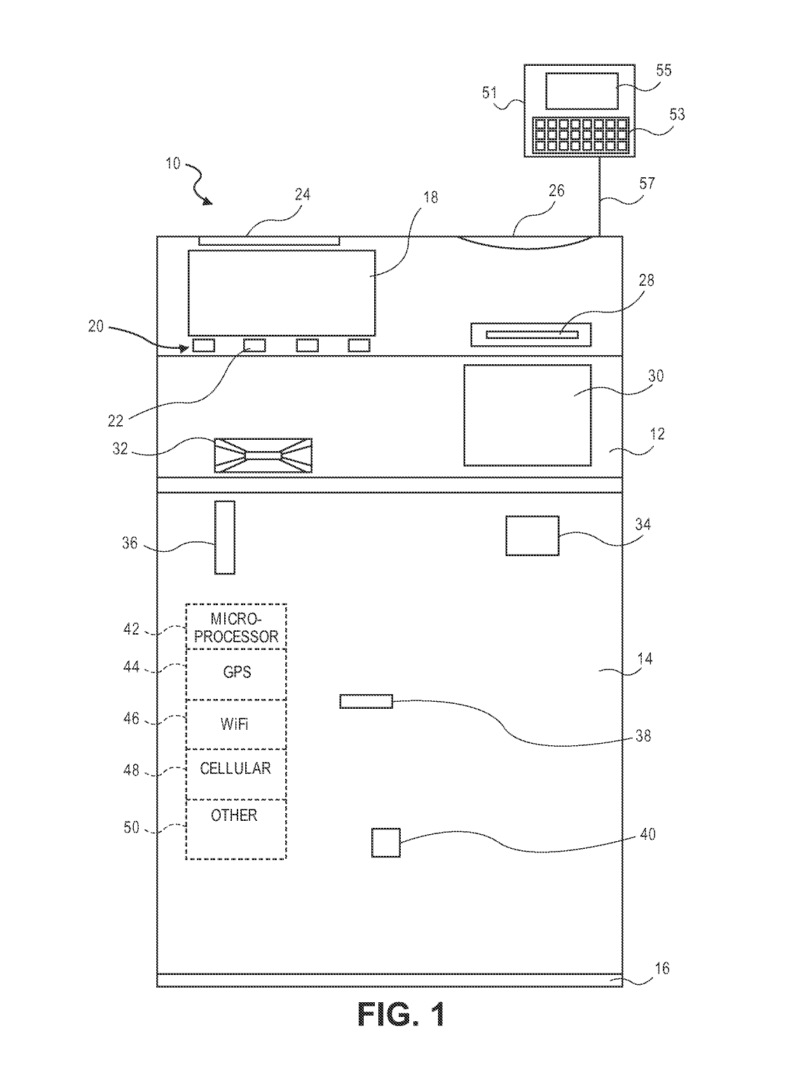

An embodiment of the present inventive apparatus is illustrated in FIG. 1. FIG. 1 illustrates a fare collection box 10. The fare collection box 10 has a lid or top 12 attached to a body 14. The body 14 and the top or lid 12 sit on a base 16. In some embodiments, the base 16 may be attached to the floor of a vehicle such as a bus, train, tram, trolley, marine vessel, airplane, or any other vehicle. In other embodiments, the base 16 be attached to the ground or floor when the fare collection box 10 is located in a fixed position such as at a station.

In some embodiments, the fare collection box or farebox 10 may include a display screen 18. The display screen 18 may be an LED screen, a plasma screen, a projection screen or any other suitable screen. The display screen 18 allows a user or operator to view messages from the fare collection box 10. Examples of these messages may include whether or not a fare is recorded as collected, an amount of money associated with the user's account or fare paying device or any other suitable message. In some embodiments, the fare collection box 10 may include a keypad 20 having keys 22. The keypad 20 may be useful as an input device to allow an operator or user to enter data into the fare collection box 10. In some embodiments, the display screen 18 may be a touchscreen thereby allowing a user or operator to enter data into the fare collection box 10 by merely touching the display screen 18. Such an embodiment may obviate the need for a keypad 20 or keys 22 and would therefore not have the keypad 20 or keys 22.

The fare collection box 10 may have a variety of apparatuses which allow the fare collection box 10 to interact with a user or rider in order to collect the fare. For example, a fare collection box 10 may have a magnetic strip reader 24 for reading magnetic strips that may be associated with a user's credit card, debit card, a transit authority provided card or some other card designed to interact with the fare collection box 10. The fare collection box 10 may also have other apparatuses designed to interact with a payment device such as an radio frequency identification (RFID) reader 26 (to read Smart cards), and a scanner 30. The scanner 30 may be able to read bar codes QR (Quick Response Code) codes or any other indicia. The indicia may exist on a slip of paper, on the screen of a personal electronic device such as, for example, a smart phone, or any other means for displaying machine-readable indicia.

In addition to interacting with the magnetic strip reader 24, the RFID reader 26, or the scanner 30, a user may also make a payment via cash. Cash payments may be accepted by a currency input 28 and or a coin slot 32. A cash return 34 and coin return 36 are provided in some embodiments in order to give change back to a user other embodiments may not provide change. A printer having an output 38 allows the fare collection box 10 to provide a user with a printed receipt, transfer, or any other printed material that may be desired.

In some embodiments, a user may pay the fare by interacting with a payment device such as a credit card, smart card, personal electronic device or any other payment device with the magnetic strip reader 24, the RFID reader 26, or the scanner 30. In addition, a user may use cash and/or coins to make a payment. The user may then interact with keypad 20 or touch screen 18 to enter an amount the user wishes to pay. In other embodiments, set fares may be used in the amount deducted from the payment device or taken in cash or coin is preset and not changed by the user. In such embodiments, the preset fare may be deducted from the payment device when it interacts with the magnetic strip reader 24, the RFID reader 26, or the scanner 30.

In some embodiments, the cash fare collection box 10 is equipped with a microprocessor 42 operatively connected to a database 43. The microprocessor 42 may be configured to act as a controller or microcontroller. In some embodiments microprocessor 42 may also be operatively connected to an infrared communication port 40, a GPS unit 44, a Wi-Fi transceiver unit 46, a cellular or transceiver unit 48, and any other communications unit 50. Examples of other communication units 50 may include, but are not limited to, Bluetooth systems, radio systems or any other communication systems. The infrared communication port, GPS unit 44, Wi-Fi transceiver unit 46, and cellular transceiver unit 48 are operatively connected to the microprocessor 42 to receive and transmit data from sources external to the fare collection box 10.

Some embodiments may use and/or include communication units and/or channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), W-CDMA (Wideband Code-Division Multiple Access), Wireless Fidelity (Wi-Fi-IEEE 802.11 standard), Bluetooth, Long Term Evolution (LTE), EVolution-Data Optimized (EVDO), ZigBee (IEEE 802.15 standard), mesh network, and/or the like, and/or a combination of two or more thereof. Moreover, the communication channels are contemplated to include any future enhancements or protocols.

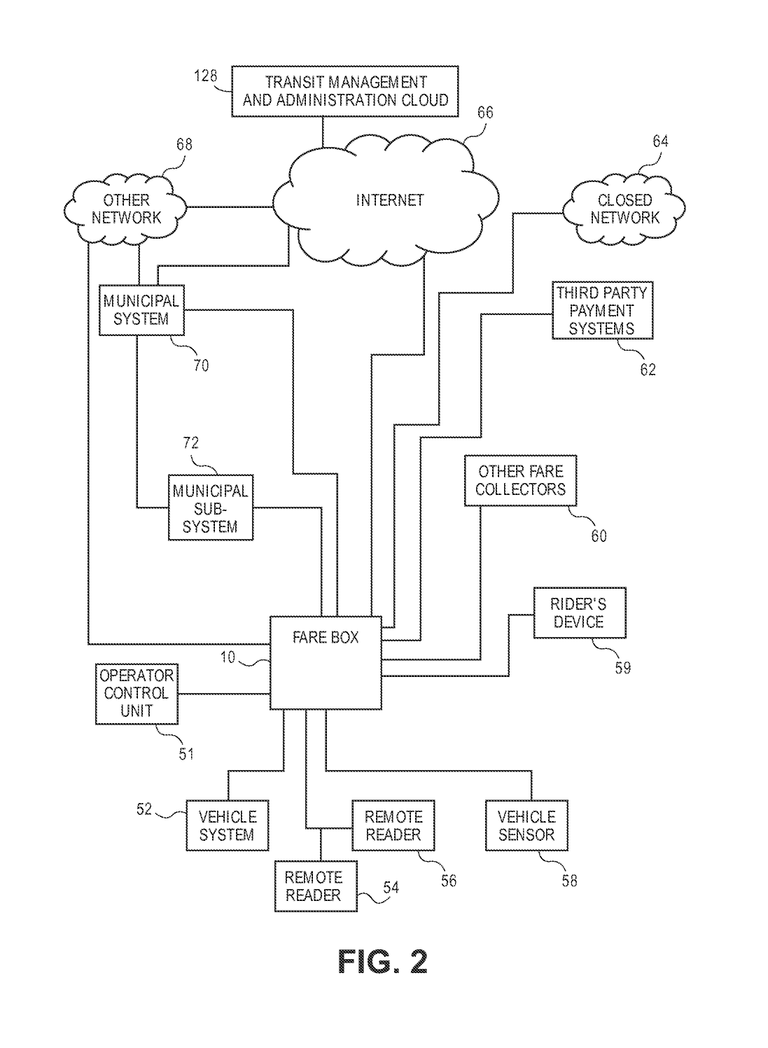

The invention may include customer communication channels that allow the farebox 10 to communicate with a customer or user's electronic device 59 (see FIG. 2) that may be any type of wired or wireless electronic communications including Radio-frequency identification (RFID), a QR code (Quick Response Code) or matrix barcode, a barcode, infrared transmission, near field communication (NFC), or other type of optical machine-readable representation of data, a magnetic stripe configured to be read by swiping past a magnetic reading head, other type of communication channel as defined herein or the like. Moreover, the invention contemplates any future enhancements or protocols implemented as customer communication channels.

The invention may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

The farebox 10 may also be connected to an operator control unit (OCU) 51. The OCU 51 may contain a keypad 53 and a display 55. (see FIG. 1) The OCU 51 may be connected to the fare collection box 10 by connection 57. The connection 57 may be a physical cable or it could be a wireless connection or any other connection suitable for sharing data and/or signals between the OCU 51 and the fare collection box 10.

The OCU 51 may be used by system operator to add, modify, or harvest data or programing from the fare collection box 10. The OCU 51 may also be used to provide diagnostic functions, updates, patches, modifications or other fixes to software or other problems associated with the fare collection box 10. The OCU 51 is not intended to be operated by customers or patrons of the transportation system but rather a system operator for performing repair, modification, updates, diagnostic, data harvesting, or any other system related tasks.

FIG. 2 is a schematic diagram of various systems, networks or other hardware that may be in communication with the farebox 10 either directly or via one or more of the infrared communication port 40, the GPS unit 44, the Wi-Fi transceiver unit 46, the cellular transceiver unit 48 or any other communications unit 50.

In embodiments where the fare collection box 10 is mounted onto a vehicle such as a bus, train, marine vessel or any other vehicle, the farebox 10 may be operatively connected to the operater control unit (OCU) 51. The farebox 10 may also be connected to a vehicle diagnostic system 52. The vehicle diagnostic system 52 may be the same as or similar to the existing diagnostic systems that monitor and diagnostic vehicles' operation. As a result, if the vehicle system has a fault, the fault may be transmitted to the fare collection box 10 which may then record the fault and/or transmit the fault to another network such as, for example, the municipal operator of the vehicle, a maintenance garage, or any other suitable place for reporting the fault. Various networks will be described further below.

The fare collection box 10 may also be connected to one or more remote readers 54 and 56. The remote readers 54 and 56 may be other fare collection boxes located on the vehicle. In some embodiments, the remote readers 54 and 56 may be identical in construction to the fare collection box 10. In other embodiments, the remote readers 54 may be scaled down versions of the fare collection box and, for example, not configured to receive cash or coins or dispense them. In other embodiments, the remote readers may also not have communication devices configured to transmit data other than to the main fare collection box 10. The remote readers 54 and 56 may, in some embodiments, have their own controllers. In other embodiments the remote readers 54 and 56 may solely communicate to the farebox 10 and input data into the microprocessor 42 of the farebox 10. The remote readers 54 and 56 may be located at other locations on the transit vehicle to allow passengers or users of a transit system to pay fares at locations on the vehicle remote from the main farebox 10 such as at alternate doors on the transit vehicle. Payment data is then transmitted to the farebox 10.

In other embodiments, one or more vehicle sensors 58 may also be operatively connected to the farebox 10 in order to provide data to the microprocessor 42 contained within the farebox 10. For example sensors 58 detect whether the vehicle doors are open, whether passengers have entered or exited the vehicle, the vehicle's proximity to various objects or any other data that may be sensed by a vehicle sensor 58. The sensors 58 signals may then be transmitted to the farebox 10.

In some embodiments, as shown in FIG. 2, the farebox 10 may also communicate with a rider's personal electronic device 59. The farebox 10 may also communicate with other fare dispensing objects 60 such as smart cards, credit cards, debit cards, transfers, tickets or any other payment device 59 as previously discussed.

In some embodiments, the farebox 10 may be configured to also communicate with other fare collectors 60 such as other fare boxes 60 associated with other vehicles. Examples of data that can be transmitted between farebox 10 and a farebox 60 associated with other vehicles can include location data of the farebox 10 and the other fare collector 60 or any other data desired to be shared between the farebox 10 and the other fare collector 60.

The farebox 10 may also be operatively connected via one of its communications systems to third-party payment systems 62. The third-party payment system 62 may be a bank associated or any other financial institution associated with a user's credit card or debit card in order to determine whether payment can be made. Other examples of payment systems 62 may include systems hosting Smart cards or providing scannable indicia as mentioned above. In some embodiments, the purpose of the ability of the farebox 10 to communicate with the outside payment system 62 is to verify that there is sufficient funds associated with the user's account and to actually deduct the funds in order to make a payment for the users use of the transportation system.

In some embodiments, the farebox 10 may also connect with closed networks 64. Closed networks may be any type of network that is closed from outside networks and designed to communicate with the farebox 10 such as, for example, a system hosting the fare collection and data processing on behalf of a transit authority associated with the farebox 10. In other embodiments, the farebox 10 may be connected to the Internet 66 and other networks 68 which may or may not also host data collection and processing as well as payment proper collection processing for the municipality or which the farebox 10 is associated with.

In some embodiments, the farebox 10 may be configured to be operatively communicative to the transit management and administration cloud 128. The transit management and administration cloud 128 may store fare collection events and other information with respect to a particular customer. Changes in fares or other data and/or events may be stored in the transit management and administration cloud 128 and communicated to the farebox 10. The transit management and administration cloud 128 may store data and rules for operation of the farebox 10 and may be administered by the transit authority or one of its agents.

In some embodiments, the operation of the transit system may have a self-contained system 70 and in some embodiments the self-contained system 70 may include one or more substations 72 which may also be able to communicate with farebox 10.

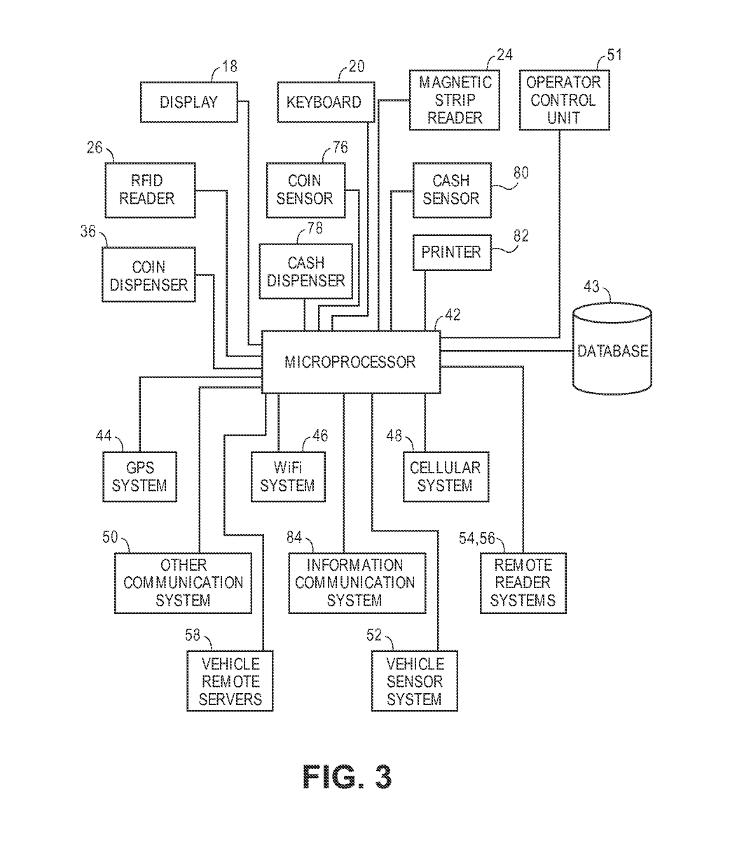

FIG. 3 is a schematic diagram showing how the microprocessor 42 is connected to various components associated with farebox 10. As shown in FIG. 3, the microprocessor 42 is operatively connected to a database 43 to allow data to be stored and retrieved from the database 43. The microprocessor 42 is also operatively connected to various communication systems for communicating with devices remote from the farebox 10 such as the GPS system 44, Wi-Fi system 46, the cellular system 48 and infrared communication system 84 and any other desired communication system 50. The microprocessor 42, may be also operatively connected with remote reader systems 54, 56 vehicle sensors 58 and the vehicle diagnostic system 52.

The microprocessor 42 is also operatively connected to the printer 82, the cash sensor 80, the magnetic strip reader 24, cash dispenser 78, the coin sensor 76, keyboard 20, the coin dispenser 36, the RFID reader 26, and the display 18. The microprocessor 42 is operatively connected to each of these devices in order to receive data and store that data in the database 43. In the case of the printer 82, the cash dispenser 78, and the coin dispenser 36, the microprocessor 42, may also operatively be connected to activate those features to dispense cash, coins, or printed documents as desired.

The microprocessor 42 is also operatively connected to the operator control unit (OCU) 51 in a way so that the OCU 51 can communicate with the processor 42 to perform any of the functions of the OCU as described above.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

What is claimed is:

1. A fare collection machine comprising:
a controller;
a database operatively connected to the controller configured to receive and provide data from the controller;
a display screen operatively connected to the controller;
a user input device operably connected to the controller;
a payment input device operably connected to the controller;
a data input device is a globally and I you okay and account executive operatively connected to the controller, the data input device configured to input to the controller data collected on the same vehicle the fare collection machine is located; and
a wireless communication device configured to commutate with a remote communication device.

2. The fare collection machine of claim 1, wherein the data input device is configured to provide data to the controller concerning at least one of any of the following: vehicle diagnostic data, passenger data and passenger payment data.

3. The fare collection machine of claim 1, where in the user input device is a keyboard.

4. The fare collection machine of claim 1, where in the user input device and the display screen both constitute a touchscreen display.

5. The fare collection machine of claim 1, wherein the payment input device includes at least one of any of the following: a scanner, a radio frequency identification (RFID) reader, a magnetic strip reader, a cash input, and a coin input.

6. The fare collection machine of claim 1, further including a printer configured to print payment data and distribute it to a user.

7. The fare collection machine of claim 1, further including a cash and coin return operably connected to the controller to allow the controller to dispense at least one of coins and cash to a user.

8. The fare collection machine of claim 1, further including an infrared communication device operably connected to the controller configured to communicate with controller.

9. The fare collection machine of claim 1, wherein the wireless communication device includes at least one of any of the following: a global positioning system (GPS), a Wi-Fi system, a cellular communication system, a satellite communication system, a Bluetooth system, and a radio.

10. The fare collection machine of claim 1, wherein the data input device further includes a device configured to receive passenger payment data located on a same vehicle as the fare collection machine but remote from the fare collection machine.

11. The fare collection machine of claim 1, wherein the payment input device is configured to communicate with a passenger's mobile device to obtain payment information.

12. The fare collection machine of claim 1, wherein the data input device is configured to provide data to the controller passenger data from a sensor located remotely from the date fare collection machine in the passenger data includes passenger ingress and egress data.

13. The fare collection machine of claim 13, further comprising a global positioning system (GPS) operatively connected to the controller to determine where a passenger boards and exits the vehicle.

14. The fare collection machine of claim 1, wherein the wireless communication device is configured to communicate with a communication device located on another vehicle.

15. A method of obtaining passenger payment information comprising:
configuring a farebox located on a vehicle to input passenger payment information;
wirelessly transmitting the passenger payment information to a receiver located remotely from the vehicle.

16. The method of claim 15, further comprising receiving passenger payment information on a device located on the vehicle and remotely located from the farebox and configured to transmit the passenger payment information to the farebox.

17. The method of claim 15, further comprising obtaining vehicle diagnostic information and transmitting the vehicle diagnostic information to a receiver located remotely from the vehicle.

18. The method of claim 15, wherein the transmitting of passenger payment information is done while the vehicle is in motion.

19. The method of claim 15, further comprising transmitting vehicle location data to a receiver located remotely from the vehicle.

20. A fare collection machine comprising:
means for processing;
means for storing and retrieving data operatively connected to the means for processing configured to receive and provide data from the means for processing;
means for displaying data operatively connected to the means for processing;
means for inputting data operably connected to the means for processing;
means for inputting payment data operably connected to the means for processing;
second means for inputting data operatively connected to the means for processing, the second means for inputting data configured to input to the means for processing data collected on the same vehicle the fare collection machine is located; and
means for wirelessly communicating configured to commutate with a communication device not located on the vehicle the collection machine is located.
